(19) United States
(12) Patent Application Publication
(10) Pub. No.: US 2009/0102785 A1
(43) Pub. Date: Apr. 23, 2009

(54) Six-Direction Button

(75) Inventors: Shi-Mu Sun, Chung Ho City (TW); Christopher Yen, Chung Ho City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AVERMEDIA TECHNOLOGIES, INC., Chung Ho City (TW)

(21) Appl. No.: 11/951,737

(22) Filed: Dec. 6, 2007

(30) Foreign Application Priority Data
Oct. 19, 2007 (TW) 96139281

(51) Int. Cl. G09G 5/00

(52) U.S. Cl. 345/156

(57) ABSTRACT

The six-direction button includes a base, a rotation detector having a rotation pin disposed on the base, a button cover coupled with the rotation pin, and four pressure detectors disposed on the base under the button cover. The button cover and the rotation pin may be rotated clockwise or counterclockwise. The pressure detectors are arranged according to an up side, a down side, a left side, and a right side of the button. The cover button cover may touch one of the four pressure detectors when the button cover is pressed.

### RELATED APPLICATIONS

This application claims priority to Taiwan Application Serial Number 96139281, filed Oct. 19, 2007, which is herein incorporated by reference.

### BACKGROUND

1. Field of Invention

The present invention relates to a control button. More particularly, the present invention relates to a six-direction button

2. Description of Related Art

With rapid technique development, various electric equipments have become very popular in our life. For example, common electric equipments include a television, a video recorder, an audio, a projector, etc. Most of the electric equipments are operated by a remote control. The functions controlled by the remote control have highly increased, and the number of the control buttons of the remote control has also increased. The large number and different kinds of control buttons on the remote control would complicate the operation interface of the remote control, and the user would not easily operate the remote control.

### SUMMARY

The invention provides a six-direction button. The six-direction button includes a base, a rotation detector having a rotation pin disposed on the base, a button cover coupled with the rotation pin, and four pressure detectors disposed on the base under the button cover. The button cover and the rotation pin may be rotated clockwise or counterclockwise. The pressure detectors are arranged according to an up side, a down side, a left side, and a right side of the button. The cover button cover touches one of the four pressure detectors when the button cover is pressed.

As embodied and broadly described herein, the six-direction button could integrate the wheeling function and the direction function and simplify the space arrangement of the operation interface.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a top view diagram of an embodiment of the six-direction button of the invention; and

FIG. 1B is a side view diagram of the embodiment of the six-direction button in FIG. 1A of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

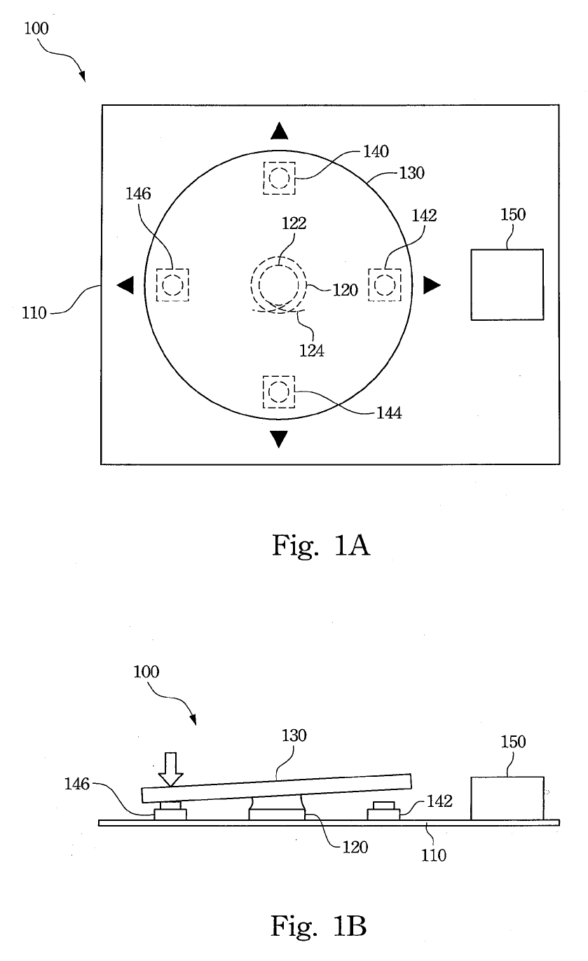

Refer to FIG. 1A and FIG. 1B. FIG. 1A and FIG. 1B illustrate a top view diagram and a side view diagram of an embodiment of the six-direction button of the invention respectively. The six-direction button 100 includes a base 110, a rotation detector 120 disposed on the base 110, a button cover 130, and four pressure detectors 140, 142, 144, 146. The rotation detector 120 has a rotation pin 122. The button cover 130 can couple with the rotation pin 122. The button cover 130 is rotated with the rotation pin 122, and the rotation detector 120 can detect the rotation value and the rotation direction of the button cover 130 by the rotation pin 122. The pressure detectors 140, 142, 144, 146 are disposed on the base 110 under the button cover 130. The pressure detectors 140, 142, 144, 146 are arranged according to an up side, a down side, a left side, and a right side of the button cover 130. A distance between the button over 130 and the base 110 is equal to or larger than a height of the pressure detectors 140, 142, 144, 146.

The six-direction button 100 may have a wheeling function and a direction function. The button cover 130 and the rotation pin 122 con rotate clockwise or counterclockwise, and the six-direction button 100 can be regarded as a wheel button. The button cover 130 further touches one of the pressure detectors 140, 142, 144, 146 when the corresponding side of the button cover 130 is pressed, and the six-direction button 100 may be regarded as a direction button.

The base 110 may be a printed circuit board. The six-direction button 100 may have a processor 150 disposed on the base 110. The signals of the pressure detectors 140, 142, 144, 146 and the rotation detector 120 can be transmitted to the processor 150 and be processed. The processor 150 can be a programmable logic device (PLD), a field programmable gate array (FPGA), a complex programmable logic device (CPLD), or an integrated circuit chip (IC chip). The shape of the button cover 130 may be a circle or a square.

The rotation detector 120 may have a torque spring 124. The torque spring 124 is mounted with the rotation pin 122. The button cover 130 can return to an original position after the button cover 130 is rotated as a wheel. The type of the pressure detector 140, 142, 144, 146 can be a press button. The six-direction button 100 may integrate the wheeling function and the direction function, and would simplify the space arrangement on the operation interface of the remote control.

The six-direction button 100 may be utilized in a remote control, such as a remote control of the document projector. As shown in this embodiment, the press button type of the pressure detector 146 is pressed when the left side of the button cover 130 is pressed. Then the signal generated by the pressure detector 146 is transmitted to the processor 150, and a cursor on the screen is moved leftward till the button cover 130 is released. In one embodiment, the document projector provides a zoom-out function when the button cover 130 and the rotation pin 122 rotate clockwise, and the document projector provides a zoom-in function when the button cover 130 and the rotation pin 122 rotate counterclockwise. In another embodiment, the document projector provides the zoom-in function when the button cover 130 and the rotation pin 122 rotate clockwise, and the document projector provides the zoom-out function when the button cover 130 and the rotation pin 122 rotate counterclockwise.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A six-direction button utilized in an operation interface, the six direction button comprising:
a base;
a rotation detector having a rotation pin disposed on the base;
a button cover coupled with the rotation pin, wherein the button cover and the rotation pin are rotated clockwise or counterclockwise; and
four pressure detectors disposed on the base under the button cover, wherein the pressure detectors are arranged according to an up side, a down side, a left side, and a right side of the button cover, and the button cover touches one of the four pressure detectors when the button cover is pressed.

2. The six-direction button of claim 1, wherein the base is a printed circuit board.

3. The six-direction button of claim 1, wherein a distance between the button cover and the base is equal to or smaller than a height of the pressure detectors.

4. The six-direction button of claim 1, wherein a shape of the button cover is a circle or a square.

5. The six-direction button of claim 1, further comprising a processor, a signal of the rotation detector and the pressure detectors is transmitted to the processor respectively.

6. The six-direction button of claim 1, wherein the operation interface is a remote control.

7. The six-direction button of claim 1, wherein the operation interface is a remote control of a document projector.

8. The six-direction button of claim 7, wherein the document projector provides a zoom-in function when the button cover and the rotation pin rotate clockwise, and the document projector provides a zoom-out function when the button cover and the rotation pin rotate counterclockwise.

9. The six-direction button of claim 7, wherein the document projector provides a zoom-out function when the button cover and the rotation pin rotate clockwise, and the document projector provides a zoom-in function when the button cover and the rotation pin rotate counterclockwise.

10. The six-direction button of claim 1, wherein the rotation detector comprises a torque spring mounted with the rotation pin for returning the rotation pin and the button cover to an original position after the button cover is rotated.
